(19) United States
(12) Patent Application Publication
(10) Pub. No.: US 2018/0288152 A1
(43) Pub. Date: Oct. 4, 2018

(54) STORAGE DYNAMIC ACCESSIBILITY MECHANISM METHOD AND APPARATUS

(71) Applicants: ANJANEYA R. CHAGAM REDDY, CHANDLER, AZ (US); Mohan J. Kumar, Aloha, OR (US); Tushar Gohad, Phoenix, AZ (US)

(72) Inventors: ANJANEYA R. CHAGAM REDDY, CHANDLER, AZ (US); Mohan J. Kumar, Aloha, OR (US); Tushar Gohad, Phoenix, AZ (US)

(21) Appl. No.: 15/477,065

(22) Filed: Apr. 1, 2017

(51) Int. Cl. H04L 29/08; G06F 3/06

(52) U.S. Cl. CPC H04L 67/1097; G06F 3/061; G06F 3/0622; G06F 3/0659; G06F 3/067; G06F 3/0653

(57) ABSTRACT

Apparatus and method for storage accessibility are disclosed herein. In some embodiments, a compute node may include one or more memories; and one or more processors in communication with the one or more memories, wherein the one or more processors include a module that is to select one or more particular storage devices of a plurality of storage devices distributed over the network in response to a data request made by an application that executes on the one or more processors, the one or more particular storage devices selected to fulfill the data request, and the module selects the one or more particular storage devices in accordance with a data object associated with the data request and one or more of current hardware operational state of respective storage devices of the plurality of storage devices and current performance characteristics of the respective storage devices of the plurality of storage devices.

### FIELD OF THE INVENTION

The present disclosure relates generally to the technical fields of computing networks and storage, and more particularly, to improving servicing of input/output requests by storage devices.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

A data center network may include a plurality of nodes which may generate, use, modify, and/or delete a large number of data content (e.g., files, documents, pages, data packets, etc.). The plurality of nodes may include a plurality of compute nodes, which may perform processing functions such as run applications, and a plurality of storage nodes, which may store data used by the applications. In some embodiments, one or more of the plurality of storage nodes may be associated with storage devices also included in the data center network, such as solid state drives (SSDs), hard disk drives (HDDs), and hybrid drives.

### BRIEF DESCRIPTION OF THE DRAWINGS

Embodiments will be readily understood by the following detailed description in conjunction with the accompanying drawings. The concepts described herein are illustrated by way of example and not by way of limitation in the accompanying figures. For simplicity and clarity of illustration, elements illustrated in the figures are not necessarily drawn to scale. Where considered appropriate, like reference labels designate corresponding or analogous elements.

FIG. 1 depicts a block diagram illustrating a network view of an example system incorporated with improved storage accessibility mechanism of the present disclosure, according to some embodiments.

FIG. 2 depicts an example diagram illustrating a rack-centric view of at least a portion of the system of FIG. 1, according to some embodiments.

FIG. 3 depicts an example block diagram illustrating a logical view of a rack scale module and cluster module, the block diagram illustrating hardware, firmware, and/or algorithmic structures and data associated with the processes performed by such structures, according to some embodiments.

FIG. 4 depicts an example process that may be performed by rack scale module and cluster module to generate a cluster map, according to some embodiments.

FIG. 5 depicts an example process that may be performed by an initiator DSS module and a target DSS module to fulfill a data request made by an application included in a compute node that includes the initiator DSS module, according to some embodiments.

FIG. 6 depicts an example process of background operations that may be performed by one or more of the targets, according to some embodiments.

FIG. 7 illustrates an example computer device suitable for use to practice aspects of the present disclosure, according to some embodiments.

FIG. 8 illustrates an example non-transitory computer-readable storage media having instructions configured to practice all or selected ones of the operations associated with the processes described herein, according to some embodiments.

### DETAILED DESCRIPTION

Embodiments of apparatuses and methods related to improved storage accessibility mechanism are described. In some embodiments, one or more modules may be included in racks that house a plurality of compute and storage components (e.g., servers, processors, hard disk drives, solid state drives, hybrid drives, memory, etc.) of a data center. The one or more modules included in the racks may be configured to automatically obtain a variety of hardware state information (e.g., operational, non-operational, about to become non-operational, actual capacity, performance characteristics) about the housed compute and storage components in real-time or near real-time, and group such compute and storage components by their characteristics into a plurality of volume groups. The volume groups information may be used with information about particular of the compute and storage components that are to perform a particular type of cluster service for the data center to form a cluster map, which defines the properties and hardware state information about the components within the cluster associated with the cluster service. Compute nodes of a plurality of compute nodes included in the data center may be provided the cluster map, so that a compute node may select particular remote storage devices capable of fulfilling data requests made by applications running on the compute node and to issue the data requests directly to the particular remote storage devices, rather than providing the data requests to one or more storage nodes of a plurality of storage nodes included in the data center (the one or more storage nodes associated with the particular remote storage devices) and then having the one or more storage nodes issue data requests to the particular remote storage devices.

In some embodiments, a compute node of a plurality of compute nodes may be distributed over a network, the compute node including one or more memories; and one or more processors in communication with the one or more memories, wherein the one or more processors include a module that is to select one or more particular storage devices of a plurality of storage devices distributed over the network in response to a data request made by an application that executes on the one or more processors, the one or more particular storage devices selected to fulfill the data request, and wherein the module selects the one or more particular storage devices in accordance with a data object associated with the data request and one or more of current hardware operational state of respective storage devices of the plurality of storage devices and current performance characteristics of the respective storage devices of the plurality of storage devices. These and other aspects of the present disclosure will be more fully described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As used herein, the term “logic” and “module” may refer to, be part of, or include an application specific integrated circuit (ASIC), an electronic circuit, a processor (shared, dedicated, or group), and/or memory (shared, dedicated, or group) that execute one or more software or firmware programs having machine instructions (generated from an assembler and/or a compiler), a combinational logic circuit, and/or other suitable components that provide the described functionality.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

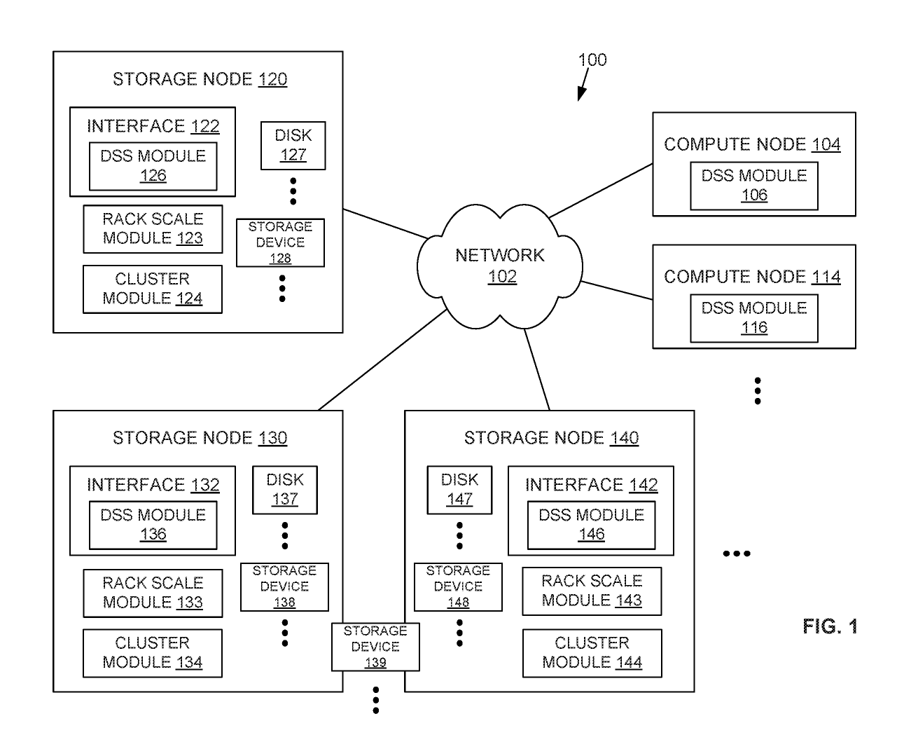

FIG. 1 depicts a block diagram illustrating a network view of an example system 100 incorporated with improved storage accessibility mechanism of the present disclosure, according to some embodiments. System 100 may comprise a computing network, a data center, a computing fabric, a storage fabric, a compute and storage fabric, and the like. In some embodiments, system 100 may include a network 102; a plurality of compute nodes 104, 114; and a plurality of storage nodes 120, 130, 140. Network 102 may be coupled to and in communication with the plurality of compute nodes 104, 114 and the plurality of storage nodes 120, 130, 140 (which may collectively be referred to as nodes).

In some embodiments, network 102 may comprise one or more switches, routers, firewalls, gateways, relays, repeaters, interconnects, network management controllers, servers, memory, processors, and/or other components configured to interconnect and/or facilitate interconnection of nodes 104, 114, 120, 130, 140 to each other. Without limitation, data objects, messages, and other data may be communicated between a first node to a second node of the plurality of nodes 104, 114, 120, 130, 140. The network 102 may also be referred to as a fabric, compute fabric, or cloud.

Each compute node of the plurality of compute nodes 104, 114 may include one or more compute components such as, but not limited to, servers, processors, memory, processing servers, memory servers, multi-core processors, multi-core servers, and/or the like configured to provide at least one particular process or network service. A compute node may comprise a physical compute node, in which its compute components may be located proximate to each other (e.g., located in the same rack, same drawer or tray of a rack, adjacent racks, adjacent drawers or trays of rack(s), same data center, etc.) or a logical compute node, in which its compute components may be distributed geographically from each other such as in cloud computing environments (e.g., located at different data centers, distal racks from each other, etc.). More or less than two compute nodes may be included in system 100. For example, system 100 may include hundreds or thousands of compute nodes.

In some embodiments, each of compute nodes 104, 114 may be configured to run one or more applications, in which an application may execute on a variety of different operating system environments such as, but not limited to, virtual machines (VMs), containers, and/or bare metal environments. Alternatively or in addition to, compute nodes 104, 114 may be configured to perform one or more functions that may be associated with data requests or needs. Application or functionality performed on a compute node may have a data request or need that involves storage external to the compute node. A data request or need may comprise an input/output (IO) request, read request, write request, or the like to be fulfilled by a remote storage (e.g., storage device 128, 138, 139, and/or 148).

To handle data requests involving remote storage, each compute node of the plurality of compute nodes 104, 114 may include a distributed storage service (DSS) module. Compute node 104 may include a DSS module 106 and the compute node 114 may include a DSS module 116. In response to a data request within the compute node 104, DSS module 106 may be configured to determine which remote storage to provide the data request and facilitate communications to and from the determined remote storage to complete the data request (e.g., provide the data request command to DSS module 126, 136, or 146). As described in detail below, DSS module 106 may have access to real-time or near real-time hardware state management information as well as hardware cluster state management information associated with the remote storage, which may be used to issue data requests (directly) to the remote storage of interest using reduced or minimal intermediating components. In some embodiments, real-time or near real-time hardware state management information and hardware cluster state management information may be obtained, determined, and/or maintained by rack scale modules 123, 133, 143 and cluster modules 124, 134, 134. DSS module 116 may be similarly configured with respect to data requests within the compute node 114. DSS modules 106, 116 may also be referred to as initiator DSS modules, host DSS modules, initiator modules, compute node side DSS modules, and the like.

Each storage node of the plurality of storage nodes 120, 130, 140 may include one or more storage components such as, but not limited to, interfaces, disks, storage, hard drive disks (HDSS), flash based storage, storage processors or servers, and/or the like configured to provide data read and write operations/services for the system 100. A storage node may comprise a physical storage node, in which its storage components may be located proximate to each other (e.g., located in the same rack, same drawer or tray of a rack, adjacent racks, adjacent drawers or trays of rack(s), same data center, etc.) or a logical storage node, in which its storage components may be distributed geographically from each other such as in cloud computing environments (e.g., located at different data centers, distal racks from each other, etc.). Storage node 120 may, for example, include an interface 122 and one or more disks 127; storage node 130 may include an interface 132 and one or more disks 137; and storage node 140 may include an interface 142 and one or more disks 147. More or less than three storage nodes may be included in system 100. For example, system 100 may include hundreds or thousands of storage nodes.

A storage node may also be associated with one or more additional storage, which may be remotely located from the storage node and/or provisioned separately to facilitate additional flexibility in storage capabilities. In some embodiments, such additional storage may comprise solid state drives (SSDs), non-volatile memory (NVM), non-volatile dual in-line memory (DIMM), flash-based storage, hybrid drives, and/or storage which communicate with host(s) over a non-volatile memory express-over fabric (NVMe-oF) protocol (also referred to as NVMe-oF targets or targets). Details regarding the NVMe-oF protocol may be provided in <<www.nvmexpress.org/wp-content/uploads/NVMe_over_Fabrics_1_0_Gold_20160605.pdf>. Storage devices 128, 138, 139, 148 may comprise examples of such additional storage.

The additional storage may be associated with one or more storage nodes. A portion of an additional storage may be associated with one or more storage nodes. In other words, an additional storage and a storage node may have a one to many and/or many to one association. For example, an additional storage may be partitioned into five sections, with a first partition being associated with a first storage node, second and third partitions being associated with a second storage node, a part of a fourth partition being associated with a third storage node, and another part of the fourth partition and a fifth partition being associated with a fourth storage node. As another example, storage node 120 may be associated with one or more of storage devices 128; storage 130 may be associated with one or more of storage devices 138, 139; and storage node 140 may be associated with one or more of storage devices 139, 148.

In some embodiments, each of the storage nodes of the plurality of storage nodes 120, 130, 140 may further include an interface configured to provide processing functionalities (e.g., read controllers, write controllers, background storage operations, foreground storage operations, etc.) associated with storage, access, and/or maintenance of data in the disks and storage device(s) of the storage node. The interface may also be referred to as a storage processor or server. The interface, in turn, may include a DSS module to correspondingly handle data requests communicated from the DSS module 106 or 116 at the storage node side and/or one or more processing functionalities as discussed above. DSS modules included in the storage nodes may also be referred to as target DSS modules, target modules, and the like. As shown in FIG. 1, interfaces 122, 132, 142 may be respectively included in storage nodes 120, 130, 140. DSS modules 126, 136, 146 may be respectively included in interfaces 122, 132, 142. In some embodiments, interfaces 122, 132, 142 (or DSS modules 126, 136, 146) may communicate with respective associated storage devices 128, 138, 139, 148 over a network fabric, such as network 102.

In some embodiments, the real-time or near real-time hardware state management and hardware cluster state management information used by the DSS modules 106, 116 of compute nodes 104, 114 may be obtained, generated, and/or maintained by the rack scale modules 123, 133, 143 and cluster modules 124, 134, 144 associated with storage nodes 120, 130, 140 and/or storage devices 128, 138, 139, 148, respectively. As described in detail below, the rack scale modules 123, 133, 143 and cluster modules 124, 134, 144 may be included in components provisioned on a rack level. Accordingly, depending on which racks of components together may be considered to comprise a storage node and/or storage devices associated with a storage node and/or the extent of redundancy associated with the rack scale or cluster modules, the number and existence of the rack scale modules, or cluster modules, or both for a storage node and/or storage devices may vary. For instance, more than one cluster module 124 may be associated with the storage node 120 for redundancy purposes. As another example, cluster module 124 may be omitted if cluster module 134 may serve both of the storage nodes 120, 130 and/or storage devices 128, 138, 139.

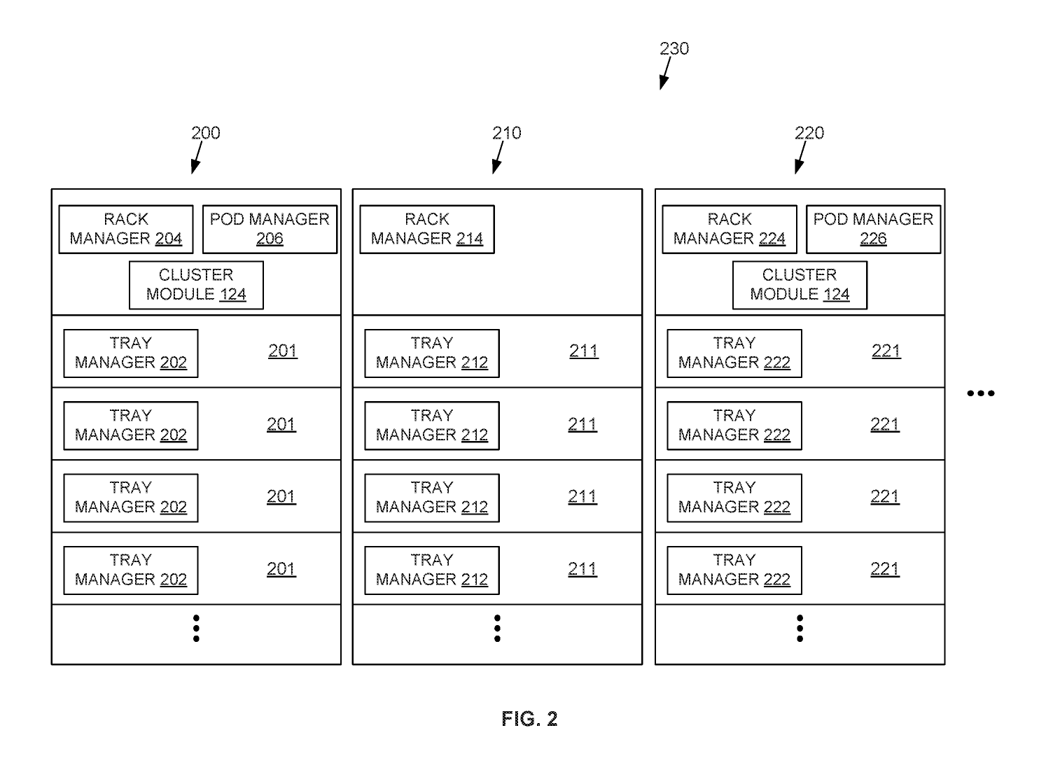

FIG. 2 depicts an example diagram illustrating a rack-centric view of at least a portion of the system 100, according to some embodiments. A collection or pool of racks 230 (also referred to as a pod of racks, rack pod, or pod) may comprise a plurality of racks 200, 210, 220, in which the collection of racks 230 may comprise, for example, approximately fifteen to twenty-five racks. The collection of racks 230 may comprise racks associated with one or more storage nodes and its associated storage devices (e.g., NVMe-oF targets), compute nodes, and/or other logical grouping of components in the system 100. A rack of the plurality of racks 200, 210, 220 may comprise a physical structure or cabinet located in a data center, configured to hold a plurality of compute and/or storage components in respective plurality of component drawers or trays. For example, racks 200, 210, 220 may include respective plurality of component drawers or trays 201, 211, 221.

In order to facilitate operation of the compute and/or storage components inserted in a rack (which may be referred to as client components from a rack's point of view), each rack may also include “utility” components (e.g., power connections, network connections, thermal or cooling management, thermal sensors, etc.) and rack management components (e.g., hardware, firmware, circuitry, sensors, processors, detectors, management network infrastructure, and the like). In some embodiments of the present disclosure, rack management components of a rack may be configured to automatically discover, detect, obtain, analyze, maintain, and/or otherwise manage a variety of hardware state information associated with each hardware component (e.g., storage devices, servers, memory, processors, interfaces, disks, etc.) inserted into (or pulled from) any of the rack's component drawers or trays. Alternatively, the rack management components may manage hardware state information associated with at least storage devices (e.g., NVMe-oF target) as well as one or more other hardware components (e.g., disks, servers, processors, memory, etc.) inserted into (or pulled from) the rack's component drawers or trays.

For example, when a storage devices may be inserted into a particular component tray/drawer of a particular rack, the particular component tray/drawer may include hardware or firmware (e.g., sensors, detectors, circuitry) configured to detect insertion of the storage devices and other information about the storage devices. Such hardware/firmware, in turn, may communicate via the rack management network infrastructure to a component that may collect such information from a plurality of the component trays/drawers and/or a plurality of the racks (e.g., the racks comprising a pod). In some embodiments, hardware state management (and associated functions) may be performed using a plurality of building blocks or components—tray managers, rack managers, and pod managers, collectively referred to as a rack scale module (e.g., rack scale module 123), as described in detail below. In some embodiments, a tray manager may be associated with each component tray/drawer so as to facilitate hardware state management functionalities at the particular tray/drawer level; a rack manager may be associated with each rack so as to facilitate hardware state management functionalities at the particular rack level; and a pod manager may be associated with a particular pod of racks so as to facilitate hardware state management functionalities at the particular pod level. A lower level manager may “report” up to a next higher level manager so that the highest level manager (e.g., the pod manager) may ultimately possess a complete set of information about the hardware components of its pod of racks.

The pod manager may accordingly be in possession of the current state of each piece of hardware within its pod of racks. Nevertheless, the pod manager may not be able to collate or apply the information about its hardware components on a particular cluster service level. A given storage node and its associated storage devices may be grouped or classified into one or more clusters based on the type of service(s) to be provided by the storage node (and associated storage devices). Examples of cluster services include, without limitation, database service, analytics service, infrastructure service, object service, and the like. In some embodiments, a cluster module associated with a particular cluster service (e.g., cluster module 124, 134, or 144) may communicate with the pod manager(s) associated with the hardware components comprising the storage node(s) and associated s of the particular cluster associated with the particular cluster service in order to obtain current hardware state information. The obtained hardware state information, in turn, may be used by the cluster module to collate and/or analyze the information into current cluster hardware state information, which may be used by compute nodes (e.g., compute node 104 or 114) to fulfill data requests to storage devices (e.g., storage devices 128, 138, 139, and/or 148).

As an example, rack 200 shown in FIG. 2 may include a plurality of tray managers 202 for respective plurality of component trays/drawers 201, a rack manager 204, a pod manager 206, and the cluster module 124; rack 210 may include a plurality of tray managers 212 for respective plurality of component trays/drawers 211 and a rack manager 214; and rack 220 may include a plurality of tray managers 222 for respective plurality of component trays/drawers 221, a rack manager 224, a pod manager 226, and the cluster module 124. In some embodiments, single or multiple instances of a pod manager for the collection/pod of racks 230 may be implemented. For example, pod manager 206 may be considered the primary pod manager for the collection/pod of racks 230 and pod manager 226 may be considered a secondary pod manager to pod manager 206 (e.g., for redundancy purposes). Alternatively, pod managers 206 and 226 may collectively comprise the pod manager for the collection/pod of racks 230. As another alternative, pod manager 226 may be omitted. In yet another alternative, more than two pod managers may be distributed within the collection/pod of racks 230.

Continuing the example, cluster module 124 may be associated with a particular cluster service that are to be provided by the storage node(s) and associated storage devices included in the collection/pod of racks 230. Cluster module 124 may be co-located with the pod manager 206, 226 (e.g., in the same rack or in same component within a rack). Alternatively, cluster module 124 may be included in pod manager 206 or 226, or vice versa. In some embodiments, single or multiple instances of a cluster module for the collection/pod of racks 230 may be implemented. For example, cluster module 124 included in rack 200 may be considered the primary cluster module for the collection/pod of racks 230 and cluster module 124 included in rack 220 may be considered a secondary cluster module to the one in rack 200 (e.g., for redundancy purposes). Alternatively, cluster modules 124 included in racks 200 and 220 may collectively comprise the cluster module for the collection/pod of racks 230. As another alternative, cluster module 124 included in rack 220 may be omitted. In yet another alternative, more than two cluster modules may be distributed within the collection/pod of racks 230. The number of instances and/or location of the cluster module(s) 124 may depend upon the scale and/or deployment architecture of the system 100.

To insure against an entire cluster potentially going down, compute and/or storage components of the cluster as well as the associated tray, rack, and pod managers and cluster module may be distributed among racks and/or within data centers taking into account possible rack failures, switch failures, network connection failures, power source failures, and the like. Possible failure points between initiators (e.g., a compute node) and targets (e.g., NVMe-oF targets) may also be taken into account so as to avoid single points of failure.

Each of cluster modules 134 and 144 may be deployed similar to that described above for cluster module 124 except cluster modules 134, 144 may be associated with cluster services same or different from the cluster service associated with cluster module 124. For example, cluster module 124 may be configured to provide database services, cluster module 134 may be configured to provide analytics services, and cluster module 144 may be configured to provide infrastructure services for the system 100.

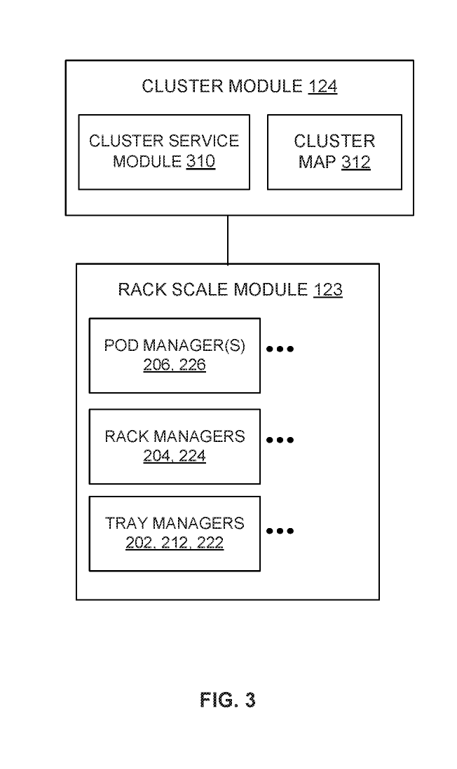

FIG. 3 depicts an example block diagram illustrating a logical view of the rack scale module 123 and cluster module 124, the block diagram illustrating hardware, firmware, and/or algorithmic structures and data associated with the processes performed by such structures, according to some embodiments. The following description of rack scale module 123 and cluster module 124 may similarly apply to rack scale module 133 and cluster module 134, and to rack scale module 143 and cluster module 144. FIG. 3 illustrates example modules and data that may be included in, used by, and/or associated with rack 200 (or rack processor associated with rack 200), rack 210 (or rack processor associated with rack 210), rack 220 (or rack processor associated with rack 220), compute node 104, compute node 114, storage node 120, storage node 130, storage node 140, and the like, according to some embodiments.

In some embodiments, rack scale module 123 may include tray managers 202, 212, 222, rack managers 204, 224, and pod manager(s) 206 and/or 226. Rack scale module 123 may also be referred to as rack scale design (RSD). In some embodiments, the tray managers may comprise the lowest or smaller building block. Each of the tray managers 202, 212, 222 may be configured to automatically discover, detect, or obtain characteristics of hardware components within its tray/drawer (e.g., obtain hardware state information at a tray level). Each of the tray managers 202, 212, 222 may be implemented as firmware, such as one or more chipsets running software or logic. Alternatively, one or more of the tray managers 202, 212, 22 may comprise hardware (e.g., sensors, detectors) and/or software.

The next higher building block from tray managers may comprise the rack managers. Each of the rack managers 204, 224 may be configured to automatically discover, detect, or obtain detect characteristics of the rack (e.g., obtain hardware state information at a rack level). In some embodiments, at least some of the hardware state information at the rack level for a given rack may be provided by the tray managers included in the given rack. Each of the rack managers 204, 224 may be implemented as firmware, such as one or more chipsets running software or logic. Alternatively, one or more of the rack managers 204, 224 may comprise hardware (e.g., sensors, detectors) and/or software.

The next higher building block from rack managers may comprise the pod manager(s). Each of the pod manager(s) 206 and/or 226 may be configured to collate, analyze, or otherwise use the hardware state information at the rack and tray levels for its associated trays and racks to generate hardware state information at the pod level for the hardware components included in the pod. In some embodiments, the pod managers 206, 226 may be implemented as software comprising one or more instructions to be executed by one or more processors included in processors, servers, or the like within the storage node(s) or rack(s) designated to be within the pod associated with the pod managers 206, 226. Alternatively, one or more of the pod managers 206, 226 may be implemented as hardware and/or software.

In some embodiments, tray managers 202, 212, 222, rack managers 204, 224, and pod manager(s) 206 and/or 226 may communicate with each other using a rack management network or other communication mechanisms (e.g., a wireless network), which may be the same or different from network 102.

Cluster module 124 may include a cluster service module 310 and a cluster map 312. The cluster module 124 may be in communication with the rack scale module 123. The cluster service module 310 may be configured to generate, obtain, provide, and/or manage cluster hardware state information associated with the hardware components deployed to provide a particular cluster service within the system 100. Cluster service module 310 may have information or requirements at the cluster level (and other possible information) which may be applied to the hardware state information at the pod level from pod manager(s) 206 and/or 226 to result in the cluster hardware state information. In some embodiments, the cluster hardware state information and other associated information (e.g., object storage service metadata) may comprise the cluster map 312. Cluster map 312 may also be referred to as cluster map information or data.

In some embodiments, the cluster service module 310 may be implemented as software comprising one or more instructions to be executed by one or more processors included in processors, servers, or the like within the storage node(s) or rack(s) designated to be within the pod associated with the pod managers 206, 226. Alternatively, cluster service module 310 may be implemented as hardware and/or software. Cluster map 312 may be stored in storage media having a faster access time than HDSS, in some embodiments. As described in detail below, cluster map 312 may be provided to DSS module 106 or 116 included in compute node 104 or 114, respectively, and the DSS module 106 or 116, in turn, may issue data request commands to selectively ones of the DSS module 126, 136, or 146 included in storage node 120, 130, or 140 in accordance with the storage devices(s) to fulfill the data requests.

In some embodiments, one or more of the tray managers 202, 212, 222, rack managers 204, 224, pod managers 206, 226, rack scale module 123, cluster service module 310, cluster module 124, and DSS modules 106, 116, 126, 136, 146 may be implemented as software comprising one or more instructions to be executed by one or more processors or servers included in the system 100. In some embodiments, the one or more instructions may be stored and/or executed in a trusted execution environment (TEE) of the one or more processors or servers. Alternatively, one or more of the tray managers 202, 212, 222, rack managers 204, 224, pod managers 206, 226, rack scale module 123, cluster service module 310, cluster module 124, and DSS modules 106, 116, 126, 136, 146 may be implemented as firmware or hardware such as, but not limited to, an application specific integrated circuit (ASIC), programmable array logic (PAL), field programmable gate array (FPGA), circuitry, on-chip circuitry, on-chip memory, and the like.

Although managers 202, 212, 222, 204, 224, 206, 226, modules 123, 124, 310, and cluster map 312 may be depicted as distinct components in FIG. 3, one or more of managers 202, 212, 222, 204, 224, 206, 226, modules 123, 124, 310, and cluster map 312 may be implemented as fewer or more components than illustrated.

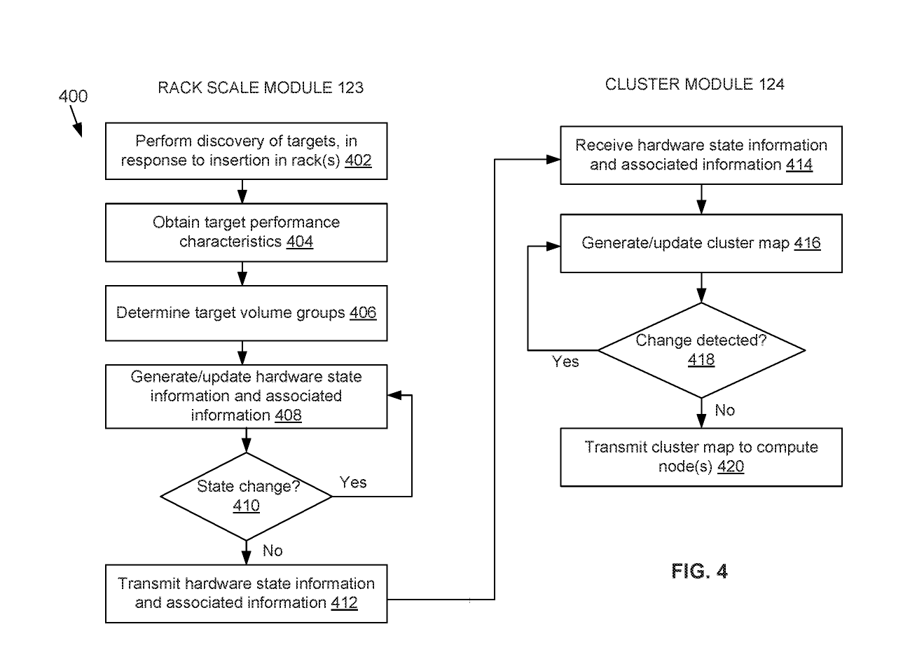

FIG. 4 depicts an example process 400 that may be performed by rack scale module 123 and cluster module 124 to generate the cluster map 312, according to some embodiments. Process 400 is described with respect to generating a cluster map associated with storage devices 128, 138, 139, and/or 148 (also referred to as NVMe-oF targets or targets). Nevertheless, it is understood that process 400 may also be implemented to generate a cluster map of any hardware components associated with the particular cluster service of the cluster map. Process 400 may likewise be implemented to generate a cluster map for each of the other types of cluster services of the system 100.

At a block 402, tray managers included in the rack scale module 123 may be configured to perform discovery of each of the NVMe-oF targets upon being plugged into or inserted to respective trays/drawers. A variety of real-time, near real-time, or current information about the target itself, the state of the target, and tray/drawer information, as well as other associated hardware-related information may be obtained (e.g., via automatic detection, interrogation of targets, target registration mechanism, contribution of third party information, and the like). Examples of information discovered about each target may include, without limitation, target working status (e.g., working/up status, not working/down status, about to stop working, out for service, newly plugged in, etc.), time and date of inclusion in the tray/drawer, time and date of removal from the tray/drawer, tray/drawer identifier, tray/drawer location within the rack, tray/drawer's state information (e.g., power source, network, thermal, etc. conditions), target's nominal capacity, target's actual capacity, target type, target model/serial/manufacturer information, number of drives, type of drive, drive capacity, drive speed, and the like.

Rack managers associated with racks for which the trays/drawers may be discovering targets may be configured to obtain real-time, near real-time, or current information about such racks. Examples of information discovered for each rack in which a target is undergoing discovery may include, without limitation, rack identifier, rack's spatial location (e.g., within a data center, location coordinates, etc.), which data center rack may be located, rack state information (e.g., power source, network, thermal, etc. conditions), and the like.

At a block 404, tray, rack, and/or pod managers of the rack scale module 123 may be configured to obtain (or further discover) target performance characteristics from the discovered targets. Target performance characteristics may include, for example, drive speeds, drive capacities, drive quality of service (QoS), drive supported services (e.g., compression or no compression, type of compression, encryption or no encryption, etc.), and the like. In some embodiments, block 404 may be optional if target performance characteristics may be obtained during the discovery phase of block 402.

Upon completion of target discovery and gathering of target performance characteristics, such obtained information may be provided from the tray and rack managers to pod manager(s) included in the rack scale module 123. The pod manager(s), in turn, may be configured to determine or classify the targets (newly discovered as well as any previously discovered) within the pod to target volume groups based on the target performance characteristics of the targets, at a block 406. Each target volume group of a plurality of target volume groups may be defined by particular target performance characteristics different from another target volume group of the plurality of target volume groups.

Next at a block 408, the pod manager(s) may be configured to generate, collate, or otherwise prepare the target-related information into hardware state information and other associated information, to be provided to the cluster module 124. Among other things, the generated information may comprise, without limitation, target volume groupings (determined in block 406), discovered target information (from blocks 402, 404), pod topology information about each target (e.g., spatial coordinates for each target), target connection information for compute nodes to actually connect to particular targets (e.g., target Internet protocol (IP) addresses, target security credentials, protocols supported by each target, etc.), and the like.

Once target-related information may be initially obtained and analyzed into generated information at block 408, the generated information may be updated upon target changes, such as when a target's operational state changes from up to down or a new target is plugged into a rack included in the pod. To that end, pod manager(s) may be configured to monitor for occurrence of changes at a block 410. In some embodiments, detection of target changes may be pushed by tray and/or rack managers to the pod manager(s). Alternatively, a pull model may be implemented to obtain current change information.

When a change occurs (yes branch of block 410), process 400 may return to block 408 in order for the pod manager(s) to update the generated information in accordance with the change. In some instances, a change to a particular target may cause the particular target to be reclassified in a target volume group different from its previous target volume group.

When no change has been detected (no branch of block 410), the generated information of block 408 may be transmitted to and received by the cluster module 124, at blocks 412 and 414, respectively. In embodiments where the pod manager(s) and the cluster module may be combined, blocks 412 and 414 may be omitted.

Upon receipt of the generated information, the cluster service module 310 included in the cluster module 124 may be configured to generate the cluster map 312 based on the received generated information and information obtained from other source(s), at a block 416. An example of information from other source(s) may comprise, without limitation, object storage service metadata which may identify entity clients being hosted on the system 100 (e.g., hosting of company A's website, providing online payment services for company B, etc.)(also referred to as tenants), entity client account information, identification of which compute and/or storage nodes may be associated with which entity clients, and the like. In some embodiments, cluster map 312 may include, without limitation, a cluster name or identifier, list of targets within the cluster, state of each target within the cluster, target volume groups of the cluster, target performance characteristics of each target volume group of the plurality of target volume groups, classification of each target within the cluster to target volume groups, pod topology information about the targets, target connection information, information about target deployment within the racks, and other target-related and/or cluster-related information.

In some embodiments, the cluster map 312 may include the following hierarchical relationship:
Level 0: Pod name
Level 1: Zone
Level 2: Rack
Level 3: Storage pool
Level 4: Storage target
Level 5: Storage target volume group.

Upon generation of the initial cluster map 312, the cluster service module 310 may be configured to keep it current. When a change to the information upon which the cluster map 312 may be based may have changed (yes branch of block 418), then process 400 may return to block 416 for the cluster service module 310 to update the cluster map 312. For example, when the pod manager(s) provide new generated information (or otherwise indicate a change in the previously provided generated information), an update to the cluster map 312 may be triggered. Otherwise, if no change is detected (no branch of block 418), then the cluster service module 310 may be configured to transmit the cluster map 312 (or a portion of the cluster map 312) to one or more compute nodes, such as compute node 104 and/or 114, at a block 420. In some embodiments, the cluster map may be provided to the compute node(s) using a push model. Alternatively, the cluster map may be provided to the compute node(s) using a pull model.

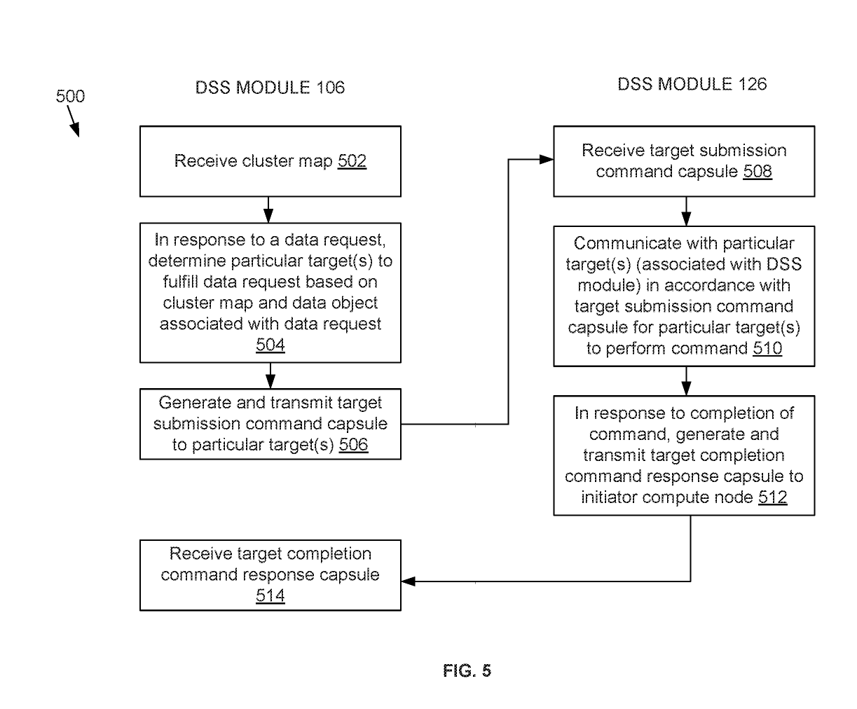

FIG. 5 depicts an example process 500 that may be performed by an initiator DSS module (e.g., DSS module 106) and a target DSS module (e.g., DSS module 126) to fulfill a data request made by an application included in a compute node that includes the initiator DSS module (e.g., compute node 104), according to some embodiments.

At a block 502, DSS module 106 may be configured to receive (a copy of) a cluster map, such as the cluster map 312, from the cluster service module 310. A cluster map may be received in response to the transmission of block 420 in FIG. 4. In some embodiments, block 502 may be performed more than once, such as each time a more current cluster map may be generated in response to a change in one or more targets. Hence, DSS module 106 may possess the most current information about the relevant targets at all times. The received cluster map may be saved in one or more memories included in the compute node 104.

Next at a block 504, in response to a data request (e.g., an IO request, a read request, a write request) from an application running on the compute node 104, the DSS module 106 may be configured to determine/identify which particular target(s) are to fulfill the data request based on at least information included in the received cluster map and the data object associated with the data request. DSS module 106 may compute a consistent hash of the data object, and map to particular target(s) and target volume group(s). In embodiments where write requests may include maintaining one or more redundant or backup copies of the data objects associated with the write requests, the particular target(s) determined or selected from the plurality of targets included in the cluster may include one or more targets for the primary copy and one or more targets for the secondary/redundant/backup copies. The determined particular target(s) may also be referred to as destination targets.

As an example, for a data request comprising a write request, the data object to be written may be of a particular size and have certain access requirements (e.g., fastest access required). Thus, the DSS module 106 may analyze the cluster map for the target volume group(s) having target performance characteristics that match the particular size and access requirements of the data object. Then one or more targets from among the matching target volume group(s) may be selected as the particular target(s) which are to perform the write operation(s) of the data object. As another example, when a data request may comprise a read request and the data object to be accessed may be stored across more than one target, the particular target(s) identified may comprise more than one target.

In alternative embodiments, determination of the particular target(s) may also take into account factors such as load balancing, round robin, and/or other considerations in addition to the cluster map and data object.

Accordingly, compute node 104 may make the data request directly to one or more suitable targets, because one or more of the current hardware operational state and the current performance characteristics of targets (as well as other information as discussed above) may be available to the compute node 104 at all times (e.g., in the received current cluster map), rather than compute node 104 making the data request to a storage node and then the storage node in turn, generating and issuing a data request to certain targets. Since each data request may be associated with a round-trip back to the initiating compute node (e.g., data request completion response), each additional “hop” in the data request fulfillment pathway may be considered doubled due to the round-trip nature of data requests. Even further, each redundant or back up copy in a write request additionally amplifies the impact of each additional “hop.”

Next at a block 506, the DSS module 106 may be configured to generate and transmit (or facilitate generation and/or transmission of) one or more target submission command capsule (also referred to as submission command capsule or IO request command) to the particular target(s) determined in block 504. The target submission command capsule may comprise submission of the data request to appropriate transmission queues. The target submission command capsule may comprise a capsule issued in accordance with the NVMe-oF protocol for NVMe-oF targets.

Correspondingly, the target submission command capsule may be received by the DSS modules associated with the particular target(s), at a block 508. For example, if the particular target(s) comprises one or more storage devices 128, then the capsule may be transmitted over the network 102 to DSS module 126.

Next at a block 510, the recipient or destination DSS module(s) may communicate with and/or facilitate performance of the data request by the particular target(s). Continuing the example, DSS module 126 may communicate with the particular one or more storage devices 128 for performance of the data request.

Upon completion of the data request, at a block 512, the recipient or destination DSS module(s) may generate and transmit (or facilitate generation and/or transmission of) one or more target completion command response capsule (also referred to as completion command response capsule, IO request response, or IO request command response) to the initiating compute node. The target completion command response capsule may indicate completion of the data request by each of the particular target(s). The target completion command response capsule may comprise a capsule issued in accordance with the NVMe-oF protocol. The target completion command response capsule may be referred to as a completion command response capsule.

Lastly, the target completion command response capsule may be received by the initiating compute node, e.g., the DSS module 106, at a block 514.

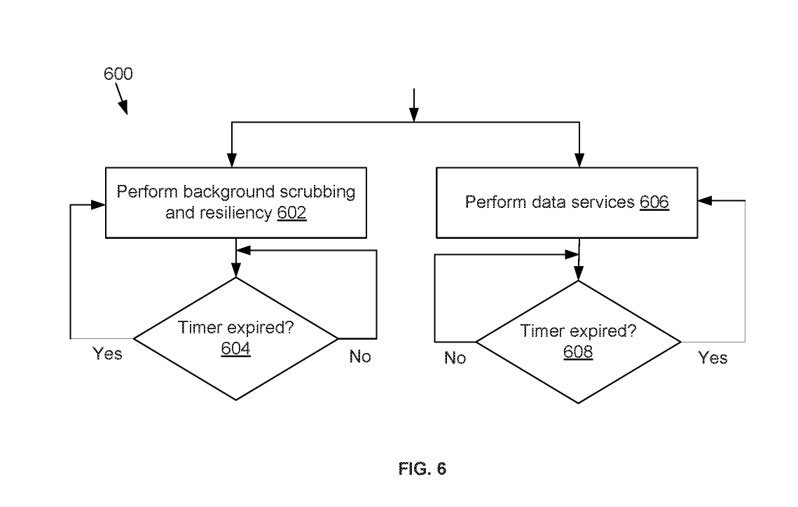

FIG. 6 depicts an example process 600 of background operations that may be performed by one or more of the targets (e.g., storage devices 128, 138, 139, 148), according to some embodiments. In some embodiments, DSS module 126, 136, 146 associated with the respective targets may facilitate performance of one or more of the background operations.

At a block 602, all the data stored in a target may undergo background scrubbing and resiliency. In some embodiments, for each stored data object of a target, a stored value of a hash of the data object may be compared to a later/currently computed hash value. If the two hash values for the same data object do not match, then the stored data object may be deemed to be corrupt. Upon detection of a data object corruption, the corrupted data object may be replaced with an uncorrupted copy of the data object (e.g., a backup copy) stored in the cluster.

Such background scrubbing may be performed periodically for each target. When a timer associated with performing background scrubbing and resiliency may have expired (yes branch of block 604), process 600 may return to block 602 for the next round of background scrubbing and resiliency. Otherwise the timer may not have expired (no branch of block 604) and the time period to start background scrubbing and resiliency has not yet occurred.

Simultaneous with or separately from block 602, the target may also perform one or more data services such as, but not limited to, caching, tiering, compression, de-duping, erasure codes, and the like, at a block 606. The data services may be performed to improve and/or optimize space utilization, data access speed, and the like. One or more of the data services may be performed at the same or different times from each other.

One or more of the data services may be performed periodically for each target. When a timer associated with performing data services (or select data services) may have expired (yes branch of block 608), process 600 may return to block 606 for the next round of data services performance. Otherwise the timer may not have expired (no branch of block 608) and process 600 may wait to perform the next round of data services.

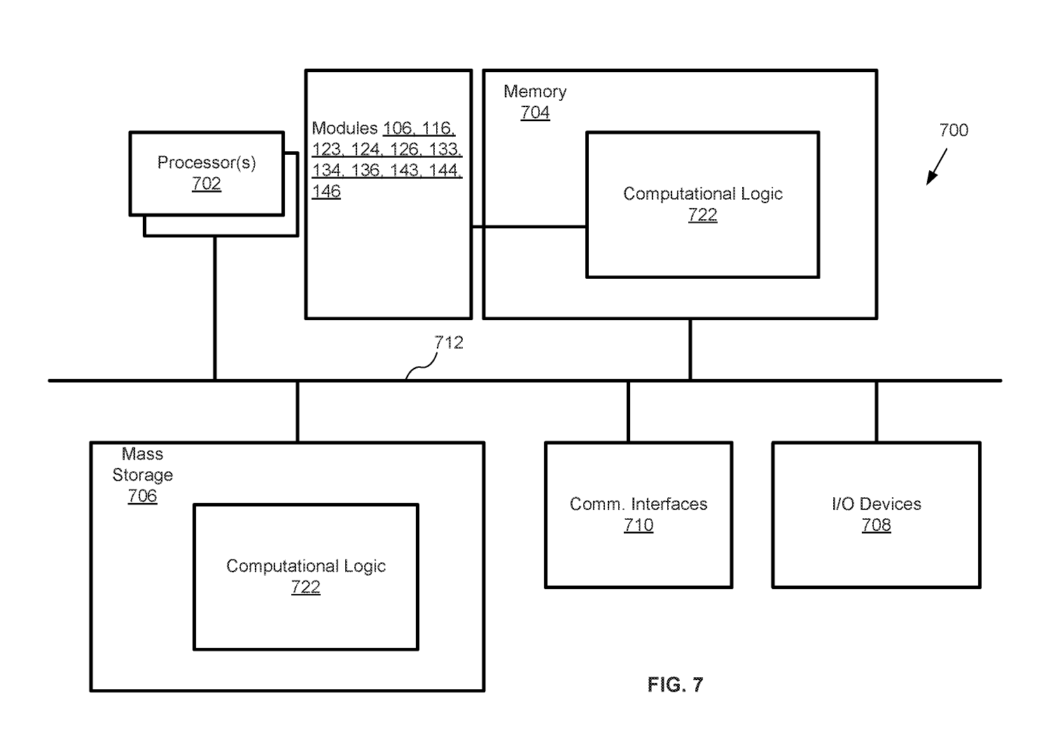

FIG. 7 illustrates an example computer device 700 suitable for use to practice aspects of the present disclosure, in accordance with various embodiments. In some embodiments, computer device 700 may comprise at least a portion of any of the compute node 104, compute node 114, storage node 120, storage node 130, storage node 140, rack 200, rack 210, and/or rack 220. As shown, computer device 700 may include one or more processors 702, and system memory 704. The processor 702 may include any type of processors. The processor 702 may be implemented as an integrated circuit having a single core or multi-cores, e.g., a multi-core microprocessor. The computer device 700 may include mass storage devices 706 (such as diskette, hard drive, volatile memory (e.g., DRAM), compact disc read only memory (CD-ROM), digital versatile disk (DVD), flash memory, non-volatile memory (NVM), solid state memory, and so forth). In general, system memory 704 and/or mass storage devices 706 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computer device 700 may further include input/output (I/O) devices 708 such as a microphone, sensors, display, keyboard, cursor control, remote control, gaming controller, image capture device, and so forth and communication interfaces 710 (such as network interface cards, modems, infrared receivers, radio receivers (e.g., Bluetooth)), antennas, and so forth.

The communication interfaces 710 may include communication chips (not shown) that may be configured to operate the device 700 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 710 may operate in accordance with other wireless protocols in other embodiments. In some embodiments, computer device 700 may be configured to operate within a converged Ethernet network (e.g., using transmission control protocol/Internet protocol (TCP/IP)), remote direct memory access (RDMA) protocol (e.g., internet wide area RDMA protocol (iWARP), RDMA over converged Ethernet (ROCE) version 1, ROCE version 2, InfiniBand standard), and/or the like.

The above-described computer device 700 elements may be coupled to each other via a system bus 712, which may represent one or more buses. In the case of multiple buses, they may be bridged by one or more bus bridges (not shown). Each of these elements may perform its conventional functions known in the art. In particular, system memory 704 and mass storage devices 706 may be employed to store a working copy and a permanent copy of the programming instructions implementing the operations associated with system 100, e.g., operations associated with providing one or more of modules 106, 116, 123, 124, 126, 133, 134, 136, 143, 144, 146 as described above, generally shown as computational logic 722. Computational logic 722 may be implemented by assembler instructions supported by processor(s) 702 or high-level languages that may be compiled into such instructions. The permanent copy of the programming instructions may be placed into mass storage devices 706 in the factory, or in the field, through, for example, a distribution medium (not shown), such as a compact disc (CD), or through communication interfaces 710 (from a distribution server (not shown)).

In some embodiments, one or more of modules 106, 116, 123, 124, 126, 133, 134, 136, 143, 144, 146 may be implemented in hardware integrated with, e.g., communication interface 710. In other embodiments, one or more of modules 106, 116, 123, 124, 126, 133, 134, 136, 143, 144, 146 (or some functions of modules 106, 116, 123, 124, 126, 133, 134, 136, 143, 144, 146) may be implemented in a hardware accelerator integrated with, e.g., processor 702, to accompany the central processing units (CPU) of processor 702.

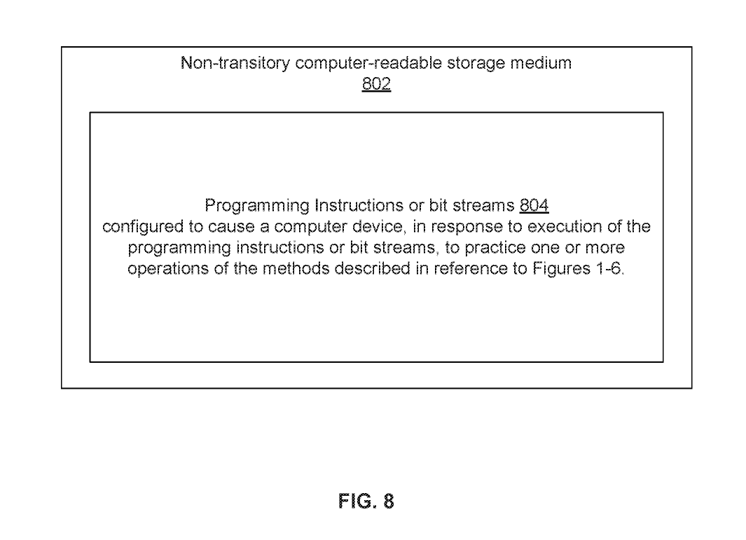

FIG. 8 illustrates an example non-transitory computer-readable storage media 802 having instructions configured to practice all or selected ones of the operations associated with the processes described above. As illustrated, non-transitory computer-readable storage medium 802 may include a number of programming instructions 804 configured to implement one or more of modules 106, 116, 123, 124, 126, 133, 134, 136, 143, 144, 146, or bit streams 804 to configure the hardware accelerators to implement some of the functions of modules 106, 116, 123, 124, 126, 133, 134, 136, 143, 144, 146. Programming instructions 804 may be configured to enable a device, e.g., computer device 700, in response to execution of the programming instructions, to perform one or more operations of the processes described in reference to FIGS. 1-6. In alternate embodiments, programming instructions/bit streams 804 may be disposed on multiple non-transitory computer-readable storage media 802 instead. In still other embodiments, programming instructions/bit streams 804 may be encoded in transitory computer-readable signals.

Referring again to FIG. 7, the number, capability, and/or capacity of the elements 708, 710, 712 may vary, depending on whether computer device 700 is used as a stationary computing device, such as a set-top box or desktop computer, or a mobile computing device, such as a tablet computing device, laptop computer, game console, an Internet of Things (IoT), or smartphone. Their constitutions are otherwise known, and accordingly will not be further described.

At least one of processors 702 may be packaged together with memory having computational logic 722 (or portion thereof) configured to practice aspects of embodiments described in reference to FIGS. 1-6. For example, computational logic 722 may be configured to include or access one or more of modules 106, 116, 123, 124, 126, 133, 134, 136, 143, 144, 146. In some embodiments, at least one of the processors 702 (or portion thereof) may be packaged together with memory having computational logic 722 configured to practice aspects of processes 300, 400 to form a System in Package (SiP) or a System on Chip (SoC).

In various implementations, the computer device 700 may comprise a desktop computer, a server, a router, a switch, or a gateway. In further implementations, the computer device 700 may be any other electronic device that processes data.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein.

Examples of the devices, systems, and/or methods of various embodiments are provided below. An embodiment of the devices, systems, and/or methods may include any one or more, and any combination of, the examples described below.

Example 1 is a compute node of a plurality of compute nodes distributed over a network, the compute node including one or more memories; and one or more processors in communication with the one or more memories, wherein the one or more processors include a module that is to select one or more particular storage devices of a plurality of storage devices distributed over the network in response to a data request made by an application that executes on the one or more processors, the one or more particular storage devices selected to fulfill the data request, and wherein the module selects the one or more particular storage devices in accordance with a data object associated with the data request and one or more of current hardware operational state of respective storage devices of the plurality of storage devices and current performance characteristics of the respective storage devices of the plurality of storage devices.

Example 2 may include the subject matter of Example 1, and may further include wherein the plurality of storage devices comprise solid state drives (SSDs), non-volatile memory (NVM), non-volatile dual in-line memory (DIMM), flash-based storage, or hybrid drives, and wherein the data request comprises a read request or a write request.

Example 3 may include the subject matter of any of Examples 1-2, and may further include wherein the module is to generate and facilitate transmission of one or more submission command capsules associated with the data request to the one or more particular storage devices over the network.

Example 4 may include the subject matter of any of Examples 1-3, and may further include wherein the plurality of storage devices are associated with respective storage nodes of a plurality of storage nodes distributed over the network, and wherein fulfillment of the data request by the one or more particular storage devices avoids storage device selection or submission command capsules generation by the storage nodes of the plurality of storage nodes.

Example 5 may include the subject matter of any of Examples 1-4, and may further include wherein the one or more processors is to receive one or more completion command response capsule from respective storage device of the one or more particular storage devices.

Example 6 may include the subject matter of any of Examples 1-5, and may further include wherein the one or more processors receive the current hardware operational state of the respective storage devices of the plurality of storage devices and the current performance characteristics of the respective storage devices of the plurality of storage devices from one or more racks that house the plurality of storage devices, and wherein the one or more memories are to store the received current hardware operational state and current performance characteristics.

Example 7 may include the subject matter of any of Examples 1-6, and may further include wherein the one or more racks that house the plurality of storage devices automatically detect or obtain the current hardware operational state and the current performance characteristics.

Example 8 may include the subject matter of any of Examples 1-7, and may further include wherein the one or more processors receive, and the one or memories store, current volume group classifications of the respective storage devices of the plurality of storage devices based on particular performance characteristics of the respective storage devices of the plurality of storage devices, current spatial topology information about the respective storage devices of the plurality of storage devices, and current connection and credential information of the respective storage devices of the plurality of storage devices.

Example 9 may include the subject matter of any of Examples 1-8, and may further include wherein the module is to select the one or more particular storage devices in accordance in one or more of the current volume group classifications, current spatial topology information, or current connection and credential information of the respective storage devices of the plurality of storage devices.

Example 10 may include the subject matter of any of Examples 1-9, and may further include wherein the current hardware operational state of the respective storage devices of the plurality of storage devices comprises a currently operational, currently non-operational, currently in the process of becoming non-operational, or currently out for service status for respective storage devices of the plurality of storage devices.

Example 11 may include the subject matter of any of Examples 1-10, and may further include wherein the current performance characteristics of the respective storage devices of the plurality of storage devices comprises one or more of current actual drive capacity, current drive speed, current quality of service (QoS), and current drive supported services for respective storage devices of the plurality of storage devices.

Example 12 is a computerized method including, in response to a read or write request within a compute node, the compute node selecting one or more particular storage devices of a plurality of storage devices distributed over a network in accordance with a data object associated with the read or write request and one or more of current hardware operational state of respective storage devices of the plurality of storage devices and current performance characteristics of the respective storage devices of the plurality of storage devices, wherein the one or more particular storage devices are to fulfill the read or write request; and generating and transmitting, by the compute node, one or more submission command capsules associated with the read or write request to the one or more particular storage devices.

Example 13 may include the subject matter of Example 12, and may further include wherein the plurality of storage devices comprise solid state drives (SSDs), non-volatile memory (NVM), non-volatile dual in-line memory (DIMM), flash-based storage, or hybrid drives.

Example 14 may include the subject matter of any of Examples 12-13, and may further include wherein the plurality of storage devices are associated with respective storage nodes of a plurality of storage nodes distributed over the network, and wherein fulfillment of the read or write request by the one or more particular storage devices avoids storage device selection or submission command capsules generation by the storage nodes of the plurality of storage nodes.

Example 15 may include the subject matter of any of Examples 12-14, and may further include receiving one or more completion command response capsule from the one or more particular storage devices upon completed fulfillment of the read or write request.

Example 16 may include the subject matter of any of Examples 12-15, and may further include receiving, at the compute node, the current hardware operational state of the respective storage devices of the plurality of storage devices and the current performance characteristics of the respective storage devices of the plurality of storage devices from one or more racks that house the plurality of storage devices; and storing, at the compute node, the received current hardware operational state and current performance characteristics.

Example 17 may include the subject matter of any of Examples 12-16, and may further include receiving, at the compute node, one or more of current volume group classifications of the respective storage devices of the plurality of storage devices based on particular performance characteristics of the respective storage devices of the plurality of storage devices, current spatial topology information about the respective storage devices of the plurality of storage devices, and current connection and credential information of the respective storage devices of the plurality of storage devices; and storing, at the compute node, the received current volume group classifications, current spatial topology information, and current connection and credential information.

Example 18 may include the subject matter of any of Examples 12-17, and may further include wherein selecting the one or more particular storage devices comprises selecting the one or more particular storage devices in accordance in one or more of the current volume group classifications, current spatial topology information, or current connection and credential information of the respective storage devices of the plurality of storage devices.

Example 19 is an apparatus including a plurality of storage targets distributed over a network; and a plurality of compute nodes distributed over the network and in communication with the plurality of compute nodes, wherein a compute node of the plurality of compute nodes includes a module that is to select one or more particular storage targets of the plurality of storage targets in response to a data request made by an application that executes on the compute node, the one or more particular storage targets to match requirements associated with the data request, and wherein the module selects the one or more particular storage targets in accordance with a data object associated with the data request and one or more of current hardware operational state of respective storage targets of the plurality of storage targets and current performance characteristics of the respective storage targets of the plurality of storage targets.

Example 20 may include the subject matter of Example 19, and may further include wherein the module is to generate and facilitate transmission of one or more submission command capsules associated with the data request to the one or more particular storage targets over the network.

Example 21 may include the subject matter of any of Examples 19-20, and may further include a plurality of storage nodes distributed over the network and in communication with the plurality of compute nodes and the plurality of storage targets, wherein the plurality of storage targets are associated with respective storage nodes of the plurality of storage nodes, and wherein fulfillment of the data request by the one or more particular storage targets avoids storage target selection or submission command capsules generation by the storage nodes of the plurality of storage nodes.

Example 22 may include the subject matter of any of Examples 19-21, and may further include wherein the compute node receives the current hardware operational state of the respective storage targets of the plurality of storage targets and the current performance characteristics of the respective storage targets of the plurality of storage targets from one or more racks that house the plurality of storage targets.

Example 23 may include the subject matter of any of Examples 19-22, and may further include wherein the one or more racks that house the plurality of storage targets automatically detect or obtain the current hardware operational state and the current performance characteristics.

Example 24 may include the subject matter of any of Examples 19-23, and may further include wherein the current hardware operational state of the respective storage targets of the plurality of storage targets comprises a currently operational, currently non-operational, currently in the process of becoming non-operational, or currently out for service status for respective storage targets of the plurality of storage targets.

Example 25 may include the subject matter of any of Examples 19-24, and may further include wherein the current performance characteristics of the respective storage targets of the plurality of storage targets comprises one or more of current actual drive capacity, current drive speed, current quality of service (QoS), and current drive supported services for respective storage targets of the plurality of storage targets.

Example 26 may include the subject matter of any of Examples 19-25, and may further include wherein the plurality of storage targets comprise a cluster of storage targets associated with a particular type of cluster service, of a plurality of cluster services, to be performed by the plurality of storage targets.

Example 27 may include the subject matter of any of Examples 19-26, and may further include wherein the particular type of cluster service comprises one of database service, analytics service, infrastructure services, or object services.

Example 28 is an apparatus including, in response to a read or write request within a means for computing, means for selecting one or more particular storage devices of a plurality of storage devices distributed over a network in accordance with a data object associated with the read or write request and one or more of current hardware operational state of respective storage devices of the plurality of storage devices and current performance characteristics of the respective storage devices of the plurality of storage devices, wherein the one or more particular storage devices are to fulfill the read or write request, and the means for selecting is included in the means for computing; and means for generating and transmitting one or more submission command capsules associated with the read or write request to the one or more particular storage devices.

Example 29 may include the subject matter of Example 28, and may further include wherein the plurality of storage devices comprise solid state drives (SSDs), non-volatile memory (NVM), non-volatile dual in-line memory (DIMM), flash-based storage, or hybrid drives.

Example 30 may include the subject matter of any of Examples 28-29, and may further include wherein the plurality of storage devices are associated with respective storage nodes of a plurality of storage nodes distributed over the network, and wherein fulfillment of the read or write request by the one or more particular storage devices avoids storage devices selection or submission command capsules generation by the storage nodes of the plurality of storage nodes.

Example 31 may include the subject matter of any of Examples 28-30, and may further include means for receiving the current hardware operational state of the respective storage devices of the plurality of storage devices and the current performance characteristics of the respective storage devices of the plurality of storage devices from one or more racks that house the plurality of storage devices; and means for storing, at the means for computing, the received current hardware operational state and current performance characteristics.

Example 32 may include the subject matter of any of Examples 28-31, and may further include means for receiving one or more of current volume group classifications of the respective storage devices of the plurality of storage devices based on particular performance characteristics of the respective storage devices of the plurality of storage devices, current spatial topology information about the respective storage devices of the plurality of storage devices, and current connection and credential information of the respective storage devices of the plurality of storage devices; and means for storing, at the means for computing, the received current volume group classifications, current spatial topology information, and current connection and credential information.

Example 33 may include the subject matter of any of Examples 28-32, and may further include wherein the means for selecting the one or more particular storage devices comprises means for selecting the one or more particular storage devices in accordance in one or more of the current volume group classifications, current spatial topology information, or current connection and credential information of the respective storage devices of the plurality of storage devices.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

We claim:

1. A compute node of a plurality of compute nodes distributed over a network, the compute node comprising:
one or more memories; and
one or more processors in communication with the one or more memories, wherein the one or more processors include a module that is to select one or more particular storage devices of a plurality of storage devices distributed over the network in response to a data request made by an application that executes on the one or more processors, the one or more particular storage devices selected to fulfill the data request, and wherein the module selects the one or more particular storage devices in accordance with a data object associated with the data request and one or more of current hardware operational state of respective storage devices of the plurality of storage devices and current performance characteristics of the respective storage devices of the plurality of storage devices.

2. The compute node of claim 1, wherein the plurality of storage devices comprise solid state drives (SSDs), non-volatile memory (NVM), non-volatile dual in-line memory (DIMM), flash-based storage, or hybrid drives, and wherein the data request comprises a read request or a write request.

3. The compute node of claim 1, wherein the module is to generate and facilitate transmission of one or more submission command capsules associated with the data request to the one or more particular storage devices over the network.

4. The compute node of claim 3, wherein the plurality of storage devices are associated with respective storage nodes of a plurality of storage nodes distributed over the network, and wherein fulfillment of the data request by the one or more particular storage devices avoids storage device selection or submission command capsules generation by the storage nodes of the plurality of storage nodes.

5. The compute node of claim 1, wherein the one or more processors receive the current hardware operational state of the respective storage devices of the plurality of storage devices and the current performance characteristics of the respective storage devices of the plurality of storage devices from one or more racks that house the plurality of storage devices, and wherein the one or more memories are to store the received current hardware operational state and current performance characteristics.

6. The compute node of claim 5, wherein the one or more racks that house the plurality of storage devices automatically detect or obtain the current hardware operational state and the current performance characteristics.

7. The compute node of claim 1, wherein the one or more processors receive, and the one or memories store, current volume group classifications of the respective storage devices of the plurality of storage devices based on particular performance characteristics of the respective storage devices of the plurality of storage devices, current spatial topology information about the respective storage devices of the plurality of storage devices, and current connection and credential information of the respective storage devices of the plurality of storage devices.

8. The compute node of claim 7, wherein the module is to select the one or more particular storage devices in accordance in one or more of the current volume group classifications, current spatial topology information, or current connection and credential information of the respective storage devices of the plurality of storage devices.

9. A computerized method comprising:
in response to a read or write request within a compute node, the compute node selecting one or more particular storage devices of a plurality of storage devices distributed over a network in accordance with a data object associated with the read or write request and one or more of current hardware operational state of respective storage devices of the plurality of storage devices and current performance characteristics of the respective storage devices of the plurality of storage devices, wherein the one or more particular storage devices are to fulfill the read or write request; and
generating and transmitting, by the compute node, one or more submission command capsules associated with the read or write request to the one or more particular storage devices.

10. The method of claim 9, wherein the plurality of storage devices comprise solid state drives (SSDs), non-volatile memory (NVM), non-volatile dual in-line memory (DIMM), flash-based storage, or hybrid drives.

11. The method of claim 9, further comprising receiving one or more completion command response capsule from the one or more particular storage devices upon completed fulfillment of the read or write request.

12. The method of claim 9, further comprising:
receiving, at the compute node, one or more of current volume group classifications of the respective storage devices of the plurality of storage devices based on particular performance characteristics of the respective storage devices of the plurality of storage devices, current spatial topology information about the respective storage devices of the plurality of storage devices, and current connection and credential information of the respective storage devices of the plurality of storage devices; and
storing, at the compute node, the received current volume group classifications, current spatial topology information, and current connection and credential information.

13. The method of claim 12, wherein selecting the one or more particular storage devices comprises selecting the one or more particular storage devices in accordance in one or more of the current volume group classifications, current spatial topology information, or current connection and credential information of the respective storage devices of the plurality of storage devices.

14. An apparatus comprising:
a plurality of storage targets distributed over a network; and
a plurality of compute nodes distributed over the network and in communication with the plurality of compute nodes, wherein a compute node of the plurality of compute nodes includes a module that is to select one or more particular storage targets of the plurality of storage targets in response to a data request made by an application that executes on the compute node, the one or more particular storage targets to match requirements associated with the data request, and wherein the module selects the one or more particular storage targets in accordance with a data object associated with the data request and one or more of current hardware operational state of respective storage targets of the plurality of storage targets and current performance characteristics of the respective storage targets of the plurality of storage targets.

15. The apparatus of claim 14, wherein the module is to generate and facilitate transmission of one or more submission command capsules associated with the data request to the one or more particular storage targets over the network.

16. The apparatus of claim 15, further comprising a plurality of storage nodes distributed over the network and in communication with the plurality of compute nodes and the plurality of storage targets, wherein the plurality of storage targets are associated with respective storage nodes of the plurality of storage nodes, and wherein fulfillment of the data request by the one or more particular storage targets avoids storage target selection or submission command capsules generation by the storage nodes of the plurality of storage nodes.

17. The apparatus of claim 14, wherein the compute node receives the current hardware operational state of the respective storage targets of the plurality of storage targets and the current performance characteristics of the respective storage targets of the plurality of storage targets from one or more racks that house the plurality of storage targets.

18. The apparatus of claim 14, wherein the current hardware operational state of the respective storage targets of the plurality of storage targets comprises a currently operational, currently non-operational, currently in the process of becoming non-operational, or currently out for service status for respective storage targets of the plurality of storage targets.

19. The apparatus of claim 14, wherein the current performance characteristics of the respective storage targets of the plurality of storage targets comprises one or more of current actual drive capacity, current drive speed, current quality of service (QoS), and current drive supported services for respective storage targets of the plurality of storage targets.

20. The apparatus of claim 14, wherein the plurality of storage targets comprise a cluster of storage targets associated with a particular type of cluster service, of a plurality of cluster services, to be performed by the plurality of storage targets.

21. The apparatus of claim 20, wherein the particular type of cluster service comprises one of database service, analytics service, infrastructure services, or object services.

22. An apparatus comprising:
in response to a read or write request within a means for computing, means for selecting one or more particular storage devices of a plurality of storage devices distributed over a network in accordance with a data object associated with the read or write request and one or more of current hardware operational state of respective storage devices of the plurality of storage devices and current performance characteristics of the respective storage devices of the plurality of storage devices, wherein the one or more particular storage devices are to fulfill the read or write request, and the means for selecting is included in the means for computing; and
means for generating and transmitting one or more submission command capsules associated with the read or write request to the one or more particular storage devices.

23. The apparatus of claim 22, wherein the plurality of storage devices comprise solid state drives (SSDs), non-volatile memory (NVM), non-volatile dual in-line memory (DIMM), flash-based storage, or hybrid drives.

24. The apparatus of claim 22, further comprising:
means for receiving the current hardware operational state of the respective storage devices of the plurality of storage devices and the current performance characteristics of the respective storage devices of the plurality of storage devices from one or more racks that house the plurality of storage devices; and
means for storing, at the means for computing, the received current hardware operational state and current performance characteristics.

25. The apparatus of claim 22, further comprising:
means for receiving one or more of current volume group classifications of the respective storage devices of the plurality of storage devices based on particular performance characteristics of the respective storage devices of the plurality of storage devices, current spatial topology information about the respective storage devices of the plurality of storage devices, and current connection and credential information of the respective storage devices of the plurality of storage devices; and
means for storing, at the means for computing, the received current volume group classifications, current spatial topology information, and current connection and credential information.

26. The apparatus of claim 25, wherein the means for selecting the one or more particular storage devices comprises means for selecting the one or more particular storage devices in accordance in one or more of the current volume group classifications, current spatial topology information, or current connection and credential information of the respective storage devices of the plurality of storage devices.
